(19) United States
(12) Patent Application Publication
(10) Pub. No.: US 2004/0058113 A1
(43) Pub. Date: Mar. 25, 2004

(54) Thermoplastic-polymer-and polyolefin-based flexible pipes for the operation of oil or gas fields

(75) Inventor: Michael Werth, Bernay (FR)

Correspondence Address: MILLEN, WHITE, ZELANO & BRANIGAN, P.C., 2200 CLARENDON BLVD., SUITE 1400, ARLINGTON, VA, 22201, US

(73) Assignee: ATOFINA, Puteaux (FR)

(21) Appl. No.: 10/601,832

(22) Filed: Jun. 24, 2003

(30) Foreign Application Priority Data
Jun. 24, 2002 (FR) 0207779

(51) Int. Cl. B32B 1/08

(52) U.S. Cl. 428/36.91

(57) ABSTRACT

The present invention relates to offshore flexible pipes in which the sealing layers comprise, in this order:

an inner layer formed from at least one thermoplastic polymer (A);

optionally, a coextrusion tie layer; and

a polyolefin layer.

According to another embodiment of the invention, the sealing layers comprise, in this order:

an inner layer formed from at least one thermoplastic polymer (A);

optionally, a coextrusion tie layer;

a polyolefin layer;

optionally, a coextrusion tie layer;

an outer layer formed from at least one thermoplastic polymer (B).

The invention also relates to flexible pipes comprising these sealing layers.

The invention also relates to the use of these flexible pipes for transporting fluids in offshore oil and gas extraction fields.

### FIELD OF THE INVENTION

The present invention relates to thermoplastic-polymer- and polyolefin-based flexible pipes for the exploitation of oil or gas fields. In the extraction of offshore oil or gas deposits it is necessary to use flexible pipes to connect the various devices around the platform. These pipes must withstand hot oil, gas, water and mixtures of at least two of these products for periods possibly as long as 20 years. These pipes consist in general of an unsealed metal inner layer formed by a profiled metal tape wound in a helix, such as an interlocked strip, which gives the pipe its shape, then a polymer is extruded over this layer in order to provide sealing, and finally, other protective and reinforcing layers are added, such as metal-fibre plies and rubber plies. For service temperatures below 40° C., the polymer is an HDPE (high-density polyethylene), up to 90° C. it is a polyamide and, above that, up to 130° C., it is a PVDF (polyvinylidene fluoride). The outside diameter of these pipes may be up to 400 to 450 mm. The present invention also relates to flexible pipes usually called “umbilicals” which serve for transporting various fluids used in the operation of offshore fields. These fluids may be methanol or hydraulic fluids. In general, these umbilicals have a much smaller diameter, for example 20 to 100 mm, than the flexible pipes which transport the gas or oil. They consist of one or more layers of thermoplastics (for example polyamide, polyetherester or polyurethane), covered with a reinforcing layer made of metal or textile fibres, and finally one or more protective layers. Such “umbilicals”, being small diameter pipes, generally do not contain an unsealed metallic layer.

The use of PA-11 in offshore flexible pipes is described in: OTC 5231 “Improved thermoplastic materials for offshore flexible pipes”, F. Dawns, J. Jarrin, T. Lefevre and M. Pelisson, IFP and Coflexip, Houston, 1986.

The use of PA-11 in offshore umbilicals is described in: “A more realistic method for predicting the compatibility of thermoplastic hoses when used in subsea umbilical systems”, J. D. Stables, I. R. Dodge and D. MacRaild, OTC 7272, 1993.

In the rest of the text, all these pipes will be denoted by the term “offshore flexible pipes”.

The flexible pipes used for transporting gas or oil from offshore deposits are made of a polyamide when the service temperature is between about 40 and 90° C.

However, it is sometimes necessary to clean these flexible pipes by making methanol run through them, for example in order to remove hydrates. The drawback of methanol is that it penetrates deeply into the polyamide. There are therefore methanol losses, but also the methanol may extract the plasticizer and/or the modifiers of the polyamide, thereby leading to deterioration in the mechanical properties and premature ageing of the flexible pipe. Umbilicals may be made of a polyamide, a polyetherester or a polyurethane and are used inter alia for injecting methanol or ethanol into the network of flexible pipes. As in the case of the above flexible pipes, the methanol penetrates into the polyamide, the polyetherester or the polyurethane and leads to the same drawbacks. The methanol or ethanol losses may also cause fires. The umbilicals are also used for hydraulic control and for injecting anticorrosion, antiwaxing, biocidal and anticaking fluids. These umbilicals need to exhibit good chemical resistance. There has already been disclosed polyamide-based pipes resistant to various fluids, including alcohol-based fuels, examples of said disclosure being:

Patent application EP 982 122 A2 discloses a pipe comprising a polyamide layer and a layer of a polyalkylene naphthenate/polyisocyanate blend. This pipe is barely permeable to a mixture consisting of (by weight) 42.5% isooctane, 42.5% toluene and 15% methanol.

Patent U.S. Pat. No. 5,858,492 discloses a multilayer pipe necessarily comprising a PVDF (polyvinylidene fluoride) layer and a layer of a polyamide/polyglutarimide blend.

Patent application EP 470 606 A1 discloses, in Example 5, a pipe for transporting petrol and consisting of an 800 μm inner layer made of impact-modified PA-6, a 100 μm layer made of grafted polypropylene and a 100 μm layer made of high-density polyethylene (HDPE) filled with carbon black.

Patent application EP 731 307 A1 discloses polyethylene pipes covered on the outside with a thin layer of a barrier polymer. The barrier polymer may be a polyamide. The thickness of the polyethylene may be from 30 to 60 mm in the case of pipes with an outside diameter up to 800 mm and from 2 to 6 mm in the case of small pipes with an outside diameter of about 20 mm, while the thickness of the polyamide is between 50 and 1000 μm. These pipes are useful as buried pipes for transporting drinking water-in contaminated ground.

Patent application US 2002/0036405 A1 discloses pipes consisting of polyethylene and polyamide for low-pressure and medium-pressure gas distribution. They consist of a polyethylene covered on the outside with a polyamide. Optionally, a tie may be placed between the polyamide and the polyethylene. The purpose of the polyamide layer is to make it easier to join the pipes—a sleeve is used which has an inside diameter equal to the outside diameter of the pipes to be joined, and adhesion is effected with a solvent—whereas polyethylene pipes are difficult to join together by polyethylene welding to itself, or they require a bulky system of flanges. The advantage of polyamide-covered pipes is that the joints using adhesively bonded sleeves take up little room, which is of paramount importance when renovating a gas main originally made of steel by introducing polyamide-covered polyethylene pipes into them. According to one variant, the polyethylene pipe may be covered with a polyamide on the inside, the connecting sleeve then being such that its outside diameter is equal to the inside diameter of the pipes to be joined. It is also possible to place a polyamide layer both on the inside and on the outside of the polyethylene. In §15, it is specified that the thickness of the polyethylene varies from 0.5 to 30 mm for diameters ranging up to 300 mm. In §48, it is specified that the thickness of the polyamide is preferably between 250 μm and 1 mm. It is therefore quite clear that these pipes are essentially made of polyethylene. It is also explained, in §58, that pipes comprising about 0.5 mm polyethylene, 0.1 mm of tie and 2.4 mm of PA-11 on the inside are resistant to liquefied gases and to condensates.

None of these documents has described the technical problem of the present invention nor offshore flexible pipes. It has now been found that by placing in the structure of the flexible pipe at least one layer of polyethylene in addition to the polyamide, polyetherester or polyurethane, the flow of methanol into the pipe is significantly reduced.

The present invention relates to offshore flexible pipes in which the sealing layers comprise, in this order:

an inner layer formed from at least one thermoplastic polymer (A);

optionally, a coextrusion tie layer; and

a polyolefin layer.

According to another embodiment of the invention, the sealing layers comprise, in this order:

an inner layer formed from at least one thermoplastic polymer (A);

optionally, a coextrusion tie layer;

a polyolefin layer;

optionally, a coextrusion tie layer;

an outer layer formed from at least one thermoplastic polymer (B).

The term “inner layer” means that this layer is in contact with the fluid being transported in the pipe, although physically in most flexible pipes the layer actually on the inside is the unsealed metal flexible layer.

The invention also relates to the flexible pipes comprising these sealing layers. The invention also relates to the use of these flexible pipes for transporting fluids in offshore oil and gas extraction fields.

As regards the thermoplastic polymer (A), this may be chosen from polyamides, blends of a polyamide and a polyolefin having a polyamide matrix, copolymers having polyamide blocks and polyether blocks, blends of polyamides and of copolymers having polyamide blocks and polyether blocks, polyetheresters and polyurethanes.

The term “polyamide” is understood to mean products resulting from the condensation:

of one or more amino acids, such as aminocaproic, 7-aminoheptanoic, 11-aminoundecanoic and 12-aminododecanoic acids, or of one or more lactams, such as caprolactam, oenantholactam and lauryllactam;

of one or more salts or mixtures of diamines, such as hexamethylenediamine, dodecamethylenediamine, metaxylylenediamine, bis-p-(aminocyclohexyl)methane and trimethylhexamethylenediamine, with diacids, such as isophthalic, terephthalic, adipic, azelaic, suberic, sebacic and dodecanedicarboxylic acids;

or mixtures of certain of these monomers, which results in copolyamides, for example PA-6/12 by the condensation of caprolactam and lauryllactam.

Advantageously, the polyamide is a polyamide chosen from PA-11, PA-12, aliphatic polyamides resulting from the condensation of an aliphatic diamine having from 6 to 12 carbon atoms and of an aliphatic diacid having from 9 to 12 carbon atoms, and 11/12 copolyamides having either more than 90% of nylon-11 units or more than 90% of nylon-12 units. Preferably they have a number-average molecular mass \overline{M}ₙ generally greater than or equal to 12000 and advantageously between 15000 and 50000. Their weight-average molecular mass \overline{M}_{w} is in general greater than 24000 and advantageously between 30000 and 100000. Their inherent viscosity (measured at 20° C. for a 5×10⁻³ g specimen per cm³ of meta-cresol is in general greater than 0.9.

As examples of aliphatic polyamides resulting from the condensation of an aliphatic diamine having from 6 to 12 carbon atoms and an aliphatic diacid having from 9 to 12 carbon atoms, mention may be made of:

PA-6,12, resulting from the condensation of hexamethylenediamine and 1,12-dodecanedioic acid;

PA-9,12, resulting from the condensation of the C₉ diamine and 1,12-dodecanedioic acid;

PA-10,10, resulting from the condensation of the C₁₀ diamine and 1,10-decanedioic acid; and

PA-10,12, resulting from the condensation of the C₉ diamine and 1,12-dodecanedioic acid.

As regards the 11/12 copolyamides having either more than 90% of nylon-11 units or more than 90% of nylon-12 units, these result from the condensation of 1-aminoundecanoic acid with lauryllactam (or the C₁₂ α, ω-amino acid).

Advantageously, the polyamide contains an organic or mineral catalyst which has been added during the polycondensation. Preferably, this is phosphoric or hypophosphoric acid. The amount of catalyst may be up to 3000 ppm, and advantageously between 50 and 1000 ppm, relative to the amount of polyamide.

It would not be outside the scope of the invention to use a polyamide blend.

Advantageously, the polyamide is PA-11 or PA-12.

The polyamide may be plasticized. This is chosen from benzenesulphonamide derivatives, such as N-butylbenzenesulphonamide (BBSA), ethyltoluene-sulphonamide or N-cyclohexyltoluenesulphonamide; esters of hydroxybenzoic acids, such as 2-ethylhexyl-para-hydroxybenzoate and 2-decylhexyl-para-hydroxybenzoate; esters or ethers of tetrahydrofurfuryl alcohol, like oligoethyleneoxytetrahydrofurfuryl alcohol; and esters of citric acid or of hydroxymalonic acid, such as oligoethyleneoxy malonate. A particularly preferred plasticizer is N-butylbenzenesulphonamide (BBSA). It would not be outside the scope of the invention to use a mixture of plasticizers. The plasticizer may be introduced into the polyamide during the polycondensation or later. The proportion of plasticizer may be from 0 to 30% by weight for 100 to 70%, advantageously 5 to 20%, of polyamide, respectively.

As regards the blends of a polyamide and of a polyolefin having a polyamide matrix, the polyamide may be one of the polyamides mentioned above and the polyolefin may be functionalized or unfunctionalized or be a blend of at least one functionalized polyolefin and/or at least one unfunctionalized polyolefin. To simplify matters, functionalized polyolefines (B1) and unfunctionalized polyolefines (B2) will be described later.

The copolymers having polyamide blocks and polyether blocks result from the polycondensation of polyamide blocks having reactive end groups with polyether blocks having reactive end groups, such as, inter alia:

1) polyamide blocks having diamine chain ends with polyoxyalkylene blocks having dicarboxylic chain ends;

2) polyamide blocks having dicarboxylic chain ends with polyoxyalkylene blocks having diamine chain ends, obtained by cyanoethylation and hydrogenation of aliphatic dihydroxylated α,ω-polyoxyalkylene blocks called polyetherdiols; and

3) polyamide blocks having dicarboxylic chain ends with polyetherdiols, the products obtained being, in this particular case, polyetheresteramides. The copolymers of the invention are advantageously of this type.

The polyamide blocks having dicarboxylic chain ends derive, for example, from the condensation of polyamide precursors in the presence of a chain-stopping carboxylic diacid.

The polyamide blocks having diamine chain ends derive, for example, from the condensation of polyamide precursors in the presence of a chain-stopping diamine.

The polymers having polyamide blocks and polyether blocks may also include randomly distributed units. These polymers may be prepared by the simultaneous reaction of the polyether and of the precursors of the polyamide blocks.

For example, a polyetherdiol, polyamide precursors and a chain-stopping diacid may be made to react together. A polymer is obtained which essentially has polyether blocks and polyamide blocks of very variable length, but in addition the various reactants that have reacted randomly, which are distributed in a random fashion along the polymer chain.

A polyether diamine, polyamide precursors and a chain-stopping diacid may also be made to react together. A polymer is obtained which has essentially polyether blocks and polyamide blocks of very variable length, but also the various reactants that have reacted randomly, which are distributed in a random fashion along the polymer chain.

The amount of polyether blocks in these copolymers having polyamide blocks and polyether blocks is advantageously from 10 to 70% and preferably from 35 to 60% by weight of the copolymer.

The polyetherdiol blocks are either used as such and copolycondensed with polyamide blocks having carboxylic end groups, or they are aminated in order to be converted into polyetherdiamines and condensed with polyamide blocks having carboxylic end groups. They may also be blended with polyamide precursors and a diacid chain stopper in order to make the polymers having polyamide blocks and polyether blocks with randomly distributed units.

The number-average molar mass \overline{M}ₙ of the polyamide blocks is between 500 and 10000 and preferably between 500 and 4000, except in the case of the polyamide blocks of the second type. The mass \overline{M}ₙ of the polyether blocks is between 100 and 6000 and preferably between 200 and 3000.

These polymers having polyamide blocks and polyether blocks, whether they derive from the copolycondensation of polyamide and polyether blocks prepared beforehand or from a 1-step reaction, have, for example, an intrinsic viscosity of between 0.8 and 2.5 measured in meta-cresol at 25° C. for an initial concentration of 0.8 g/100 ml.

As regards the polyetheresters, these are copolymers having polyester blocks and polyether blocks. They consist of soft polyether blocks, which are the residues of polyetherdiols, and of hard segments (polyester blocks) which result from the reaction of at least one dicarboxylic acid with at least one chain-extending short diol unit. The polyester blocks and the polyether blocks are linked by ester linkages resulting from the reaction of the acid functional groups of the acid with the OH functional groups of the polyetherdiol. The short chain-extending diol may be chosen from the group consisting of neopentyl glycol, cyclohexanedimethanol and aliphatic glycols of formula HO(CH₂)ₙOH in which n is an integer varying from 2 to 10. Advantageously, the diacids are aromatic dicarboxylic acids having from 8 to 14 carbon atoms. Up to 50 mol % of the dicarboxylic aromatic acid may be replaced with at least one other dicarboxylic aromatic acid having from 8 to 14 carbon atoms, and/or up to 20 mol % may be replaced with a dicarboxylic aliphatic acid having from 2 to 12 carbon atoms.

As examples of dicarboxylic aromatic acids, mention may be made of terephthalic, isophthalic, dibenzoic, naphthalenedicarboxylic acids, 4,4′-diphenylene-dicarboxylic acid, bis(p-carboxyphenyl)methane acid, ethylenebis(p-benzoic acid), 1,4-tetramethylenebis(p-oxybenzoic acid), ethylenebis(paraoxybenzoic acid) and 1,3-trimethylene bis(p-oxybenzoic acid). As examples of glycols, mention may be made of ethylene glycol, 1,3-trimethylene glycol, 1,4-tetramethylene glycol, 1,6-hexamethylene glycol, 1,3-propylene glycol, 1,8-octamethylene glycol, 1,10-decamethylene glycol and 1,4-cyclohexylenedimethanol. The copolyers having polyester blocks and polyether blocks are, for example, copolymers having polyether blocks derived from polyether diols, such as polyethylene glycol (PEG), polypropylene glycol (PPG) or polytetramethylene glycol (PTMG), dicarboxylic acid units, such as terephthalic acid, and glycol (ethanediol) or 1,4-butanediol units. The chain-linking of the polyethers and diacids forms soft segments while the chain-linking of the glycol or the butanediol with the diacids forms the hard segments of the copolyetherester. Such copolyetheresters are disclosed in patents EP 402 883 and EP 405 227. These polyetheresters are thermoplastic elastomers. They may contain plasticizers.

As regards the polyurethanes, these consist of soft polyether blocks, which are residues of polyetherdiols, and hard blocks (polyurethanes) which result from the reaction of at least one diisocyanate with at least one short diol. The short chain-extending diol may be chosen from the glycols mentioned above in the description of the polyether esters. The polyurethane blocks and polyether blocks are linked by linkages resulting from the reaction of the isocyanate functional groups with the OH functional groups of the polyether diol.

Polyester urethanes may also be mentioned, for example those comprising diisocyanate units, which derive from amorphous polyester diols and units derived from a short chain-extending diol. They may contain plasticizers.

Blends of at least two of these polymers (A) may be used. The thermoplastic polymer may contain standard additives such as antioxidants.

With regard to the optional tie, this thus denotes any product allowing adhesion to the thermoplastic polymer layer (A). Advantageously the tie is a functionalized polyolefin carrying a carboxylic acid or carboxylic acid anhydride functional group. It may be blended with an unfunctionalized polyolefin. To simplify matters, functionalized polyolefins (B1) and unfunctionalized polyolefins (B2) are described below.

An unfunctionalized polyolefin (B2) is conventionally a homopolymer or an alpha-olefin or diolefin copolymer, such as, for example, ethylene, propylene, 1-butene, 1-octene and butadiene. By way of example, mention may be made of:

polyethylene homopolymers and copolymers, particularly LDPE, HDPE, LLDPE (linear low-density polyethylene), VLDPE (very low-density polyethylene) and metallocene polyethylene;

propylene homopolymers or copolymers,

ethylene/alpha-olefin copolymers, such as ethylene/propylene, EPR (the abbreviation for ethylene/propylene rubber) and ethylene/propylene diene (EPDM);

styrene/ethylene-butene/styrene (SEBS), styrene/butadiene/styrene (SBS), styrene/isoprene/styrene (SIS) and styrene/ethylene-propylene/styrene (SEPS) block copolymers;

copolymers of ethylene with at least one product chosen from salts or esters of unsaturated carboxylic acids, such as alkyl (meth)acrylate (for example methyl acrylate), or vinyl esters of saturated carboxylic acids, such as vinyl acetate, the proportion of comonomer possibly being up to 40% by weight.

The functionalized polyolefin (B1) may be an alpha-olefin polymer having reactive groups (functional groups); such reactive groups are acid functional groups or anhydride functional groups. As an example, mention may be made of the above polyolefins (B2) grafted or copolymerized or terpolymerized by carboxylic acids or the corresponding salts or esters, such as (meth)acrylic acid, or else by carboxylic acid anhydrides, such as maleic anhydride. A functionalized polyolefin is, for example, a PE/EPR blend, the weight ratio of which may vary widely, for example between 40/60 and 90/10, the said blend being cografted with an anhydride, especially maleic anhydride, with a grafting ratio of, for example, 0.01 to 5% by weight.

The functionalized polyolefin (B1) may be chosen from the following (co)polymers, grafted with maleic anhydride, in which the degree of grafting is, for example, from 0.01 to 5% by weight:

PE, PP, copolymers of ethylene with propylene, butene, hexene or octene, containing for example from 35 to 80% ethylene by weight;

ethylene/alpha-olefin copolymers, such as ethylene/propylene, EPR (the abbreviation for ethylene/propylene rubber) and ethylene/propylene diene (EPDM);

styrene/ethylene-butene/styrene (SEBS), styrene/butadiene/styrene (SBS), styrene/isoprene/styrene (SIS) and styrene/ethylene-propylene/styrene (SEPS) block copolymers;

ethylene-vinyl acetate copolymers (EVA) containing up to 40% vinyl acetate by weight;

ethylene-alkyl (meth)acrylate copolymers containing up to 40% alkyl (meth)acrylate by weight; and

ethylene-vinyl acetate (EVA)/alkyl (meth)acrylate copolymers containing up to 40% by weight of comonomers.

The functionalized polyolefin (B1) may also be a copolymer or terpolymer of at least the following units: (1) ethylene; (2) an alkyl (meth)acrylate or a vinyl ester of a saturated carboxylic acid and (3) an anhydride, such as maleic anhydride, or (meth)acrylic acid.

As examples of functionalized polyolefins of the latter type, mention may be made of the following copolymers, in which ethylene preferably represents at least 60% by weight and in which the termonomer (the functional group) represents, for example, from 0.1 to 10% by weight of the copolymer:

ethylene/alkyl (meth)acrylate/(meth)acrylic acid or maleic anhydride copolymers;

ethylene/vinyl acetate/maleic anhydride copolymers; and

ethylene/vinyl acetate or alkyl (meth)acrylate/(meth)acrylic acid or maleic anhydride copolymers.

The term “alkyl (meth)acrylate” in (B1) or (B2) denotes C₁ to C₁₂ alkyl acrylates and methacrylates, these possibly being chosen from methyl acrylate, ethyl acrylate, n-butyl acrylate, isobutyl acrylate, 2-ethyl hexyl acrylate, cyclohexyl acrylate, methyl methacrylate and ethyl methacrylate.

The copolymers mentioned above, (B1) and (B2), may be random copolymers or block copolymers and have a linear or branched structure.

The molecular weight, the MFI and the density of these polyolefins may also vary widely, as a person skilled in the art will appreciate. MFI is the abbreviation for Melt Flow Index, which is measured according to the ASTM 1238 standard.

Advantageously, the unfunctionalized polyolefins (B2) are chosen from polypropylene homopolymers or copolymers and any ethylene homopolymer or copolymer of ethylene with a comonomer of the alpha-olefin type, such as propylene, butene, hexene, octene or 4-methyl-1-pentene. Mention may be made, for example, of PP, high-density PE, medium-density PE, linear low-density PE, low-density PE and very low-density PE. These polyethylenes are known to a person skilled in the art as being produced according to a “radical” process, using catalysis of the “Ziegler” type or, more recently, using catalysis referred to as “metallocene” catalysis.

Advantageously, the functionalized polyolefins (B1) are chosen from any polymer comprising alpha-olefin units and units carrying polar reactive functional groups, such as carboxylic acid or carboxylic acid anhydride functional groups. As examples of such polymers, mention may be made of ethylene-alkyl acrylate-maleic anhydride terpolymers, such as the Applicant's LOTADER®, or polyolefins grafted by maleic anhydride, such as the Applicant's OREVAC® polymers, and ethylene-alkyl acrylate-(meth)acrylate acid terpolymers.

As a first example of a tie, mention may be made of the blends comprising:

5 to 30 parts of a polymer (D) which itself comprises a blend of a polyethylene (D1) having a density of between 0.910 and 0.940 and a polymer (D2) chosen from elastomers, very low-density polyethylenes and metallocene polyethylenes, the blend (D1)+(D2) being cografted by an unsaturated carboxylic acid;

95 to 70 parts of a polyethylene (E) having a density of between 0.910 and 0.930;

the blend of (D) and (E) being such that:

its density is between 0.910 and 0.930 and

the content of grafted unsaturated carboxylic acid is between 30 and 10 000 ppm;

the MFI (ASTM D 1238: 190° C./2.16 kg) is between 0.1 and 3 g/10 min. MFI denotes the melt flow index.

The density of the tie is advantageously between 0.915 and 0.920. Advantageously, (D1) and (E) are LLDPEs; preferably, they have the same comonomer. This comonomer may be chosen from 1-hexene, 1-octene and 1-butene. The unsaturated carboxylic acid may be replaced with an unsaturated carboxylic acid anhydride.

As a second example of a tie, mention may be made of the following blends:

5 to 30 parts of a polymer (F) which itself comprises a blend of a polyethylene (F1) having a density of between 0.935 and 0.980 and a polymer (F2) chosen from elastomers, very low-density polyethylenes and ethylene copolymers, the blend (F1)+(F2) being cografted by an unsaturated carboxylic acid;

95 to 70 parts of a polyethylene (G) having a density of between 0.930 and 0.950;

the blend of (F) and (G) being such that:

its density is between 0.930 and 0.950 and advantageously between 0.930 and 0.940,

the content of grafted unsaturated carboxylic acid is between 30 and 10 000 ppm and

the MFI (melt flow index) measured according to ASTM D 1238 is between 5 and 100 g/10 min (190° C./21.6 kg).

The unsaturated carboxylic acid may be replaced with an unsaturated carboxylic acid anhydride.

As a third example of a tie, mention may be made of blends consisting of an HDPE-, LLDPE-, VLDPE- or LDPE-type polyethylene, 5 to 35% of a grafted metallocene polyethylene (grafted by an unsaturated carboxylic acid or an unsaturated carboxylic acid anhydride), and 0 to 35% of an elastomer, the total being 100%.

As a fourth example of a tie, mention may be made of the blends comprising:

5 to 35 parts of a polymer (S) which itself consists of a blend of 80 to 20 parts of a metallocene polyethylene (S1) having a density of between 0.865 and 0.915 and 20 to 80 parts of a non-metallocene LLDPE polyethylene (S2), the blend (S1)+(S2) being cografted by an unsaturated carboxylic acid;

95 to 65 parts of a polyethylene (T) chosen from polyethylene homopolymers or copolymers, and elastomers;

the blend of (S) and (T) being such that:

the content of grafted unsaturated carboxylic acid is between 30 and 100 000 ppm,

the MFI (ASTM D 1238: 190° C./2.16 kg) is between 0.1 and 10 g/10 min. MFI denotes the melt flow index and is expressed in grams per 10 minutes.

The unsaturated carboxylic acid may be replaced with an unsaturated carboxylic acid anhydride.

As regards the polyolefin layer, this may be chosen from unfunctionalized polyolefins (B2) defined above. Advantageously, high-density polyethylene is used. The high-density polyethylene (HDPE) is described in Kirk-Othmer 4^{th} edition, Vol. 17, pages 704 and 724-725. It is an ethylene polymer having a density of at least 0.94 according to ASTM D 1248-84. The term HDPE relates both to ethylene homopolymers and its copolymers with small proportions of an α-olefin. The density is advantageously between 0.940 and 0.965. In the present invention, the MFI of the HDPE is advantageously between 0.1 and 50. As an example, mention may be made of LACQTENE® 2001 TN 46.

It would not be outside the scope of the invention if the polyolefin is a blend of at least two of the polyolefins B2, optionally including a functionalized polyolefin B1. The polyolefin may, for example, be a polypropylene blended with an EPR or EPDM copolymer; the latter may optionally be plasticized or crosslinked during blending.

According to another embodiment of the invention, the sealing layers comprise, in this order:

an inner layer formed from at least one thermoplastic polymer (A);

optionally, a coextrusion tie layer;

a polyolefin layer;

optionally, a coextrusion tie layer;

an outer layer formed from at least one thermoplastic polymer (B).

The optional tie placed between the polyolefin layer and the layer of thermoplastic polymer (B) may be chosen from the same family as that optionally placed between the polyolefin layer and the layer of thermoplastic polymer (A).

The thermoplastic polymer (B) may be chosen from the same family as (A)—it may be identical or different.

The polymers of the various layers may contain standard additives such as antioxidants and stabilizers.

The total thickness of these sealing layers, that is to say the thickness of the combination of the layer of thermoplastic polymer (A), the optional tie and the polyolefin layer, or of the combination of the layer of thermoplastic polymer (A), the optional tie, the polyolefin layer, the optional tie and the layer of thermoplastic polymer (B), may for example be between 0.8 and 30 mm. In general, the thicknesses of the individual layers for off-shore pipes can be up to about 10 to 15 times the thicknesses of the layers of the laboratory pipes set forth in the examples. Generally, the thickness of the tie layer is about 5 to 8% the (A) and (B) thickness.

These flexible pipes may be manufactured by coextrusion. The reinforcing and protective layers may then be placed on the outside. If these flexible pipes contain an inner layer made of wound metal strip, then a device called a [symbol] crosshead [symbol] is used for extruding the sealing layers over this wound strip.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius and, all parts and percentages are by weight, unless otherwise indicated.

The following products were used:

Rilsan® Besno P40 TLO: this denotes a plasticized nylon-11 having an MVFI (melt volume flow index) of 3 cm³/10 min (at 235° C./10 kg) sold by Atofina;

Orevac® 18334: this denotes a coextrusion tie which is a cografted blend of polyethylenes, having an MFI of 1 g/10 min (190° C./2.16 kg) sold by Atofina;

Lacqtene® 2001 TN 46: this denotes a high-density polyethylene of 0.945 density and 0.6 MVFI (190° C./5 kg) sold by Atofina.

Tubes' of the following structures, which represent the sealing layers of offshore flexible pipes, were manufactured by coextrusion using a multilayer coextrusion head.

### EXAMPLE I

Monolayer tube made of Rilsan® Besno P40 TLO—before extrusion the PA-11 granules were treated in order to extract the oligomers therefrom.

### EXAMPLE II

Trilayer: 800 μm of Rilsan® Besno P40 TLO/50 μm of Orevac® 18334/150 μm of Lacqtene® 2001 TN46.

### EXAMPLE III

Trilayer: 650 μm of Rilsan® Besno P40 TLO/50 μm of Orevac® 18334/300 μm of Lacqtene® 2001 TN46.

### EXAMPLE IV

5 layers: Rilsan® Besno P40 TLO/Orevac® 18334/Lacqtene® 2001 TN46/Orevac® 18334/Rilsan® Besno P40 TLO with the following thicknesses 300 μm/50 μm/300 μm/50 μm/300 μm.

### EXAMPLE V

5 layers: Rilsan® Besno P40 TLO/Orevac® 18334/Lacqtene® 2001 TN46/Orevac® 18334/Rilsan® Besno P40 TLO with the following thicknesses: 375 μm/50 μm/150 μm/50 μm/375 μm.

The tubes were filled with methanol and kept at 60° C. in a fan oven. The loss of methanol was determined by measuring the weight. The tensile strength and burst pressure were also measured in order to determine the strength of the tubes. The peel force was also measured in order to demonstrate the ageing resistance of the tie.

Methanol Permeability After 50 Days at 60° C.:

| Example | I | II | III | IV | V |
|---|---|---|---|---|---|
| Permeability | 268 | 19 | 23 | 26 | 26 |
| g/m² · 24 h | | | | | |

Tensile tests were carried out on an Instron® 4302 machine at 23° C. with a pull rate of 50 mm/min. the length of tube between the jaws was 100 mm.

Results on Unaged Tubes:

| Example | I | II | III | IV | V |
|---|---|---|---|---|---|
| Yield | 38.8 | 35.4 | 33.3 | 34.2 | 32.2 |
| stress | | | | | |
| (MPa) | | | | | |
| Elongation | 275 | 348 | 246 | 246 | 239 |
| at break (%) | | | | | |

Burst test conditions: according to the DIN 73378 standard at 23° C., the tubes 23 cm in length were filled with oil and placed in the air.

Results of the Burst Tests (Unaged Tubes):

| Example | I | II | III | IV | V |
|---|---|---|---|---|---|
| Pressure | 61.9 | 55.8 | 58.4 | 57.8 | 58.1 |
| (bar) | | | | | |
| Stress | 21.5 | 19.4 | 20.3 | 20.1 | 20.2 |
| (MPa) | | | | | |

Ageing tests: the tubes of Examples I, II and IV were tested; the elongation at break relates to the failure of the inner layer which breaks first. In the multilayer tubes, other layers may have a greater elongation at break, this being the case of the tubes of the present invention.

Elongation at Break:

| Ageing (h) | Example I | Example II | Example IV |
|---|---|---|---|
| 0 | 275 | 348 | 246 |
| 408 | 169 | 186 | 152 |
| 552 | 172 | 164 | 144 |
| 1008 | 163 | 177 | 127 |
| 1512 | 168 | 156 | 122 |
| 2256 | 160 | 148 | 125 |

Bursting of the Tubes, Expressed by the Stress (MPa):

| Ageing (h) | Example I | Example II | Example IV |
|---|---|---|---|
| 0 | 21.5 | 19.4 | 20.1 |
| 408 | 21.2 | 20.7 | 19.5 |
| 552 | 21.3 | 20.7 | 19.5 |
| 1008 | 22.6 | 22.2 | 20.8 |
| 1512 | 23.4 | 22.9 | 21.2 |
| 2256 | 25.2 | 24.1 | 22.0 |

Peel tests: These were carried out on strips 10 mm in length at 23° C. and at a rate of 200 mm/min.

Results on Unaged Tubes:

| | Peel force |
|---|---|
| Example II | Outer layer/tie: 23 N/cm |
| | Tie/inner layer: no initiation, |
| | excellent adhesion |
| Example III | No initiation, excellent adhesion |
| Example IV | No initiation, excellent adhesion |
| Example V | Outer layer/tie: 28 N/cm |
| | Tie/inner layer: 37 N/cm |

Results on the Tube of Example IV:

| Ageing (h) | Peel force |
|---|---|
| 1008 | Outer layer/tie: 8.1 N/cm |
| | Tie/inner layer: 11.0 N/cm |
| 1512 | Outer layer/tie: 8.7 N/cm |
| | Tie/inner layer: 11.7 N/cm |
| 2256 | Outer layer/tie: 6.2 N/cm |
| | Tie/inner layer: 11.2 N/cm |

The preceding examples can be repeated with similar success by substituting the generically or specifically described reactants and/or operating conditions of this invention for those used in the preceding examples.

The entire disclosures of all applications, patents and publications, cited herein and of corresponding French application No. 02.07779, filed Jun. 24, 2002 are incorporated by reference herein.

From the foregoing description, one skilled in the art can easily ascertain the essential characteristics of this invention and, without departing from the spirit and scope thereof, can make various changes and modifications of the invention to adapt it to various usages and conditions.

1. An offshore flexible pipe comprising an unsealed flexible inner layer outer sealing layers, in which the sealing layers comprise, in succession:
an inner layer formed from at least one thermoplastic polymer (A);
optionally, a coextrusion tie layer;
a polyolefin layer.

2. A pipe according to claim 1, which additionally comprises, on the same side as the polyolefin layer, in succession:
optionally, a coextrusion tie layer;
an outer layer formed from at least one thermoplastic polymer (B).

3. Pipes according to claim 1 or 2, in which the polymers (A) and (B) are chosen from polyamides, blends of a polyamide and a polyolefin having a polyamide matrix, copolymers having polyamide blocks and polyether blocks, blends of polyamides and of copolymers having polyamide blocks and polyether blocks, polyetheresters and polyurethanes.

4. Pipes according to claim 3, in which the polyamides are chosen from PA-11, PA-12, aliphatic polyamides resulting from the condensation of an aliphatic diamine having from 6 to 12 carbon atoms and of an aliphatic diacid having from 9 to 12 carbon atoms and 11/12 copolyamides having either more than 90% of nylon-11 units or more than 90% of nylon-12 units.

5. Pipes according to claim 4, in which the polyamide is PA-11 or PA-12 and contains a plasticizer.

6. Pipes according to any one of the preceding claims, in which the tie is a functionalized polyolefin carrying a carboxylic acid or carboxylic acid anhydride functional group, optionally blended with an unfunctionalized polyolefin.

7. Pipes according to any one of the preceding claims, in which the polyolefin of the polyolefin layer is high-density polyethylene.

8. Use of the flexible pipes according to any one of the preceding claims for transporting fluids in offshore oil and gas extraction fields.
